(19) United States
(12) Patent Application Publication
(10) Pub. No.: US 2009/0009914 A1
(43) Pub. Date: Jan. 8, 2009

(54) Semiconductor Device Using Locating and Sign of the Spin of Electrons

(75) Inventors: Georg Schmidt, Lindenflur (DE); Charles Gould, Wurzburg (DE); Laurens W. Molenkamp, Wurzburg (DE); Christian Ruster, Hasloch (DE)

Correspondence Address: BROWDY AND NEIMARK, P.L.L.C.;624 NINTH STREET, NW, SUITE 300, WASHINGTON, DC, 20001-5303, US

(73) Assignee: ETECH AG, Schlieren (CH)

(21) Appl. No.: 11/579,655

(22) PCT Filed: May 3, 2005
(86) PCT No.: PCT/CH2005/000247

§ 371 Date: Aug. 5, 2008

Related U.S. Application Data
(60) Provisional application No. 60/568,823, filed on May 7, 2004.
(60) Provisional application No. 60/603,571, filed on Aug. 24, 2004.
(60) Provisional application No. 60/641,558, filed on Dec. 28, 2004.

(51) Int. Cl. G11B 5/33

(52) U.S. Cl. 360/324; G9B/5.104

(57) ABSTRACT

A spin-valve structure is provided, illustrating the layer structure used for the magnetic tunnel junction, by a method comprising the steps of providing a substrate, growing a ferromagnetic layer on the substrate, growing a tunnel barrier layer on the ferromagnetic layer, providing a first non-magnetic metallic contact on the ferromagnetic layer and providing a second non-magnetic metallic contact for the single ferromagnetic layer. Beside such a single sided structure a double-sided structure can be provided having e.g. a Ga0.94Mn0.06As/undoped GaAs/Ga0.94Mn0.06As trilayer structure on top of a semi-insulating GaAs substrate and an undoped LT-GaAs buffer layer. There is an inner square contact and a surrounding electrical back contact. This sample structure makes it possible to perform two-probe magnetoresistance measurements through both ferromagnets and the GaAs tunnel barrier. The resistance of the device is fully dominated by the vertical tunneling process through the tunnel barrier.

In the production of electronic circuits based upon the principles of spintronics, that is, using the location and sign of the spin of the electron rather than its charge as the pre-eminent factor under control, it is necessary to create ‘spin-valve’ controls to allow the manipulation of the electrons as the computational requirements of the circuits require. The invention relates to such devices and especially to spin-valves. According to one aspect of the invention, it is related more especially to single-sided spin-valves in spintronics devices. According to another aspect of the invention, it is related more especially to double-sided spin-valves in spintronics devices.

Such spin-valves have hitherto been made by forming a sandwich structure of which both the outer layers are ferromagnetic metals or semiconductors. This perceived requirement has led to certain restrictions on optimal spin-valve design and performance.

The present invention describes devices wherein a spin-valve like effect may be obtained where one and only one of the outer sandwich layers is a ferromagnetic semiconductor, the other being a non-magnetic material. This ‘single-sided spin valve’ construction offers a wider range of possibilities for spin-valve construction and enhanced performance. The spin-valve effect under such circumstances is believed to arise from a change of the density of states that contribute to the tunneling. The origin of the effect is still under academic research and debate, but as such does not affect this disclosure.

Observations made of a tunnel barrier of AlOx (aluminium oxide) between a non-magnetic metal (Au) and a ferromagnetic material (GaMn)As, show this can exhibit a huge magneto-resistance which can show the signature of a spin valve.

If, as in crystallographically cubic GaMnAs a magnetic semiconducting layer is prepared that has in principle two easy axes of magnetization in the plane (in this case by the layer having a [001] orientation so that the [100] and [010] axes lie in the plane), then because these axes are in fact slightly different, due to thermal, strain or other effects, although magnetic reversal along the easier of the two axes occurs by 180° reversal as is conventional, magnetic reversal along the less-easy axis involves a ‘half way house’ condition, stable across a particular range of applied reverse magnetic field, where 90° reversal has occurred (this 90° reversal being either ‘left’ or ‘right’ oriented with regard to the original direction of magnetization). This in turn implies that magnetic reversal is occurring by nucleation and movement of domain walls rather than by simultaneous bulk magnetic rotation.

For both axes there is a very similar density of states in the semiconductor, but importantly the actual transport carriers have to be matched also in momentum to their density of states on the counterside of the devices (Al₂O₃ was used as the tunnel barrier and Ti(Au) as the counterside—the counterside being here defined as the material/structure on the other side of the tunneling barrier from the semiconductor). Consequently for tunneling orthogonally through the tunneling barrier there must be no lateral component of momentum. Hence most of the states are forbidden to tunnel, and the tunneling current is to some extent spin-polarized. Hence, although the two easy axes are very similar in energy and in density of states, the difference in the momentum distribution of the density of states is highly significant for the tunneling current, which thus depends appreciably on the orientation of the magnetization on the GaMnAs.

Since the easiest axis can also be selected by e.g., applied magnetic fields, this permits the creation of spin valves, GMR heads etc. where (a) there is only one ferromagnetic layer involved (b) the advantages of semiconductors over metals can be deployed and (c) greater sensitivity in particular can be expected.

Thus, it has been observed that the effect is dependant upon the amount, composition (especially amount of ferromagnetic elements present) and orientation of the crystal structures involved, which alters the strength and orientation of the magnetic field with respect to the tunnel barrier.

Also, the reversal of the sign of the magnetization, which is believed to occur through the formation and propagation of domain walls, is a function of temperature, whilst the magnetic anisotropy remains temperature independent. This leads to the observation that the magnetic and transport anisotropy are not strictly correlated, and can be independently optimized.

On the other side a super-giant tunneling anisotropic magnetoresistance in an epitaxially grown (Ga,Mn)As/GaAs/(Ga,Mn)As structure is disclosed. The effect arises from a strong dependence of the electronic structure of ferromagnetic semiconductors on the magnetization orientation rather than from a parallel or anti-parallel alignment of the contacts. The key novel spintronic features of this effect are: (i) both normal and inverted spin-valve like signals; (ii) a large non-hysteretic magnetoresistance for magnetic fields perpendicular to the interfaces; (iii) magnetization orientations for external resistance are, in general, not aligned with the magnetic easy and hard axis, and (iv) enormous amplification of the effect at low bias and temperatures.

### SUMMARY OF THE INVENTION

From observations of spin-valve like tunnel magnetoresistance using a single magnetic layer we introduce a new class of spintronic devices in which a spin valve like effect results from strong spin-orbit coupling in a single ferromagnetic layer rather than from injection and detection of a spin-polarized current by two coupled ferromagnets. A spin-valve like signal is observed in a normal-metal/insulator/ferromagnetic-semiconductor tunneling device. This behavior is caused by the interplay of the anisotropic density of states in (Ga,Mn)As with respect to the magnetization direction, and the two-step magnetization reversal process in this material.

Devices relying on spin manipulation are hoped to provide low-dissipative alternatives for microelectronics, which may revert the current trend of increasing electricity consumption due to computers and the threat that as the size of individual electronic parts scales down, the increasing dissipative losses will make them inoperable. Spintronics is also expected to lead to full integration of information processing and storage functionalities opening an attractive prospect for the realization of instant on-and-off computers. One of the coveted goals of current spintronics research is to realize a device with metal spin-valve like behavior (as suggested by J. S. Moodera, L. R. Kinder, T. M. Wong, R. Meservey, Phys. Rev. Lett. 74, 3273 (1995)) in an all semiconductor-based structure which would provide new means for integration of spintronics with existing microelectronics technologies. An oft proposed scheme for achieving such a device consists of a tunnel barrier between two ferromagnetic semiconductors. As such, (Ga,Mn)As/(Al,Ga)As/(Ga,Mn)As structures have previously been studied (e.g., see Y. Higo, H. Shimizu and M. Tanaka, J. Appl. Phys. 89, 6745, (2001): and M. Yamanouch, D. Chiba, F. Matsukura and H. Ohno, Nature 428, 539 (2004)), with some promising results. However, realizing the full potential of these systems will require a complete understanding of the physics of tunneling into (Ga,Mn)As, which we have found to be rather different than previously thought.

In this spirit, we investigate transport in a structure consisting of a single ferromagnetic (Ga,Mn)As layer fitted with a tunnel barrier and a non-magnetic metal contact. Our measurements reveal the unexpected result that this system exhibits a spin-valve like signal. Some of the design complexities of standard spin-valves, e.g., the need to induce different coercive fields in the two ferromagnets, are immediately eliminated in this structure. We here disclose some of the rich experimental properties of the single (Ga,Mn)As tunneling structure and provide an interpretation of the measured spin-valve like effect as a tunneling anisotropic magnetoresistance (TAMR) due to the two-step magnetization reversal process and a magnetization orientation dependent density of states (DOS) in the (Ga,Mn)As layer.

There is thus a need for a simple semiconductor device using location and sign of the spin of electrons, such as is described in the present invention.

It is an object of the invention to provide such a semiconductor functionally employing a stable partial reverse magnetized state in semiconductor materials.

It is a further object of the invention to provide a very large tunneling anisotropic magnetoresistance in a double sided ferromagnetic semiconductor tunnel junction.

A main component needed to realize the full potential of this technology is a device with similar behavior as current metal-based spin valves, and with novel spintronic features unattainable in their metal counterparts. Previous attempts in this direction have yielded promising spin-valve results apparently mimicking the functionality of the metal devices. However, our recent discovery of tunneling anisotropic magnetoresistance (TAMR) in a single (Ga,Mn)As layer structure suggests that the moderate magnetoresistance (MR) effects observed so far in structures such as the one mentioned by Y. Higo, H. Shimizu and M. Tanaka, J. Appl. Phys. 89, 6745, (2001); and M. Yamanouch, D. Chiba, F. Matsukura and H. Ohno, Nature 428, 539 (2004) may originate from TAMR rather than the traditional metal tunneling MR (TMR). If this is the case, the device behavior should be much richer than for the TMR, and could offer many new functionalities not possible in metal based devices. To investigate this hypothesis, we have fashioned a tunnel structure based on the ferromagnetic semiconductor (Ga,Mn)As. We report the existence of a huge TAMR effect exceeding 100 000% in these structures.

### SHORT DESCRIPTION OF THE DRAWINGS

The invention will now be described by the following description of embodiments according to the invention, with reference to the drawing, in which:

FIG. 1: a) Hysteretic magnetoresistance curves acquired at 4.2K with 1 mV bias by sweeping the magnetic field along the 0°, 50°, and 55° directions. Spin valve like features of different widths and signs are clearly visible, delimited by two switching events labeled H_{c1} and H_{c2}. The measurements are independent of the sign of the bias; b) Schematic of the device showing the geometry of the contacts and the orientation of the crystallographic directions; c) Magnetoresistance along 30° for temperatures from 1.6 K to 20 K, showing a change of sign of the spin valve signal. The curves are vertically offset for clarity.

FIG. 2: Polar plot compiled from magnetoresistance curves at many in-plane angles. The circles indicate the switching events H_{c1} and H_{c2} extracted from the individual curves. The shaded areas are regions where the sample is in a high resistance state while the white areas indicate lower resistance. The solid line is a fit to the model described in the text.

FIG. 3: The relative difference between partial DOS at the Fermi energy for M along [010] and [100] directions is plotted separately for each of the four valence bands occupied by holes. Dotted lines correspond to MnGa concentration of 4%; black lines corresponding to 6% Mn doping are shown for comparison.

FIG. 4: The relative integrated DOS anisotropy is plotted for different Mn (left panel) and hole (right panel) concentrations. The x-axis represents the DOS at the Fermi energy that is assumed to contribute to tunneling, relative to the total DOS at the Fermi energy. Moving from left to right corresponds to gradually relaxing the momentum conservation condition.

FIG. 5: a.) illustrates the layer structure used for the magnetic tunnel junction, as prepared by low temperature molecular beam epitaxy (LT-MBE). A Ga₁₋ₓMnₓAs (x=6%, d=100 nm)/undoped GaAs/Ga₁₋ₓMnₓAs (x=6%, d=100 nm) trilayer structure was grown on top of semi-insulating GaAs substrate and an undoped LT-GaAs buffer layer. The ferromagnetic transition temperature Tc of the (Ga,Mn)As layers is 65K. b.) A schematic of the final transport device with a sample layout and contact pads.

FIG. 6: shows plots of the magnetoresistance taken at a bias of 10 mV and T=4.2K along the two principal magnetic axes of the device. The minor loops show that the magnetic anisotropy is closely associated with a transport/resistance anisotropy inherent to the device. From FIG. 6 one can see that both layers having M∥[100] is equivalent to a high resistance state of ˜700 kOhm and if their M∥[010], this corresponds to a resistance of ˜480 kOhm.

FIG. 7: shows a measurement of a very strong magnetoresistance when the magnetic field is applied perpendicular to the plane of the sample, taken at T=4.2 K with an excitation voltage of V=5 mV.

FIG. 8: When the magnetic field is applied in plane at an angle farther away from the two mutually perpendicular easy axes, the magnitude of the effect remains roughly constant, whereas the location of the sharp switching events displays a strong angular dependence which is evidenced in this Fig., wherein the magnetic field was applied in the plane of the sample, at angles ranging from 0° to 170° in steps of 10°. For better clarity, the individual magnetoresistance curves are offset vertically.

FIG. 9: Measurements of appropriate minor loops of the magnetoresistance, typical data show that both layers have their uniaxial easy axis close to φ=60°, the second and slightly less easy axis is along 150°. The dotted black curve was taken first while sweeping down from positive to negative saturation along φ=0°. It was assumed that the first and biggest jump in the resistance data is due to both layers transitioning from the closest cubic easy axis (φ=330°) to the uniaxial easy direction along φ=235°.

FIG. 10: Plot of the resistance of the device according to the invention versus the angle of the applied magnetic field, kept constant at B=300 mT, while the direction its is swept counterclockwise, taken at T=4.2K and a bias of V=5 mV.

FIG. 11: The appearance of the T-scan changes dramatically with the magnitude of the applied field as demonstrated here, where the magnetic field was carefully chosen to be slightly higher than the highest field needed along any direction for a 90° switch of the magnetization.

FIG. 12: The size of the spin valve like signal of the tunnel junction exhibits a very strong voltage dependence. The various curves are magnetoresistance measurements taken along φ=30° at a temperature of 4.2K. The excitation voltage ranges from 500 μV up to 10 mV. The low resistance state exhibits a relatively low variation, increasing from 500 kOhm to about 750 kOhm with decreasing bias.

FIG. 13: The TAMR signal increases dramatically with decreasing temperature, showing a giant spin valve signal with the magnetic field at φ=60° at a temperature of 1.7K and V=1 mV.

FIG. 14: Measurement of the perpendicular magnetoresistance of the device at 1.8K and V=1 mV.

FIG. 15: φ-scan of the resistance of the device at 1.7K and V=1 mV.

FIG. 16: Diagrams showing the amplification of the effect at low bias voltage and temperatures.

FIG. 17: Sample resistance at 0 mT, after saturating M at an angle φ. The step function behavior of the measurement makes it possible to write information to the TAMR device with an external magnetic field and later read it by measuring the resistance of the device. The data shown her is measured on the Au/AlOx/(Ga,Mn)As sample at T=4.2K (a) and the (Ga,Mn)As/GaAs/(Ga,Mn)As sample at T=4.2K (b) and T=1.8K (c).

FIG. 18: High angular resolution φ-scans (B=0 mT) measured in the transition region between the high and the low resistance state. The measurements show the existence of an intermediate resistance state at T=4.2K (a) and T=1.8K (b). In this state the angle between the two magnetizations is 90°.

FIG. 19: a) IV curve measured on the (Ga,Mn)As/GaAs/(Ga,Mn)As tunnel junction at zero magnetic field after preparing the magnetic state along φ=51° and φ=149°, close to the transition region of high and low resistance regimes in FIG. 17c. The measurement shows distinct discontinuities at V=7 mV which are evidence of current assisted switching. b) A correlation of the discontinuity of the 149° IV curve (stars) and the bistability of FIG. 18b suggests current assisted switching between the high and the intermediate (“90°”) resistance state of the sample.

FIG. 20: The magnetic state of the sample was prepared with a large field along φ=146.75° which is inside the bistability window. Then the external field was brought to zero while applying a voltage to the sample. This procedure was repeated many times and the resulting resistance value at zero magnetic field is plotted vs. the index of the measurement.

FIG. 21: SQUID on an as-grown specimen taken from the (Ga,Mn)As wafer S20. The measurement is conducted with the magnetic field oriented 15° off the [110] edge of the sample.

FIG. 22: SQUID measurements on a Au/AlOx/(Ga,Mn)As sample nominally identical to the single sided TAMR layer. The measurements confirm the validity of the employed magnetization reversal/magnetic anisotropy model. (a) Measurements with the magnetic field along the [100] easy and the [110] hard axis. (b) The measurement is conducted with the magnetic field oriented 15° off the [110] edge of the sample.

FIG. 23: SQUID measurements on a 70 nm thick (Ga,Mn)As sample covered with a thin AlOx overlayer. The covered sample shows double step switching (FIG. 23c).

FIG. 24: SQUID measurement on a 70 nm thick (Ga,Mn)As sample covered with a thin Au overlayer. Magnetic field at a small angle (<30°) with respect to one of the sample edges. The sample shows double step switching.

FIG. 25: SQUID measurements on four different (Ga,Mn)As epilayers that were simultaneously grown, but on various substrates: without intentional miscut (S97A) and with an intentional miscut of 5° into various directions (S97B to D).

### DETAILED DESCRIPTION OF PREFERRED EMBODIMENTS OF THE INVENTION

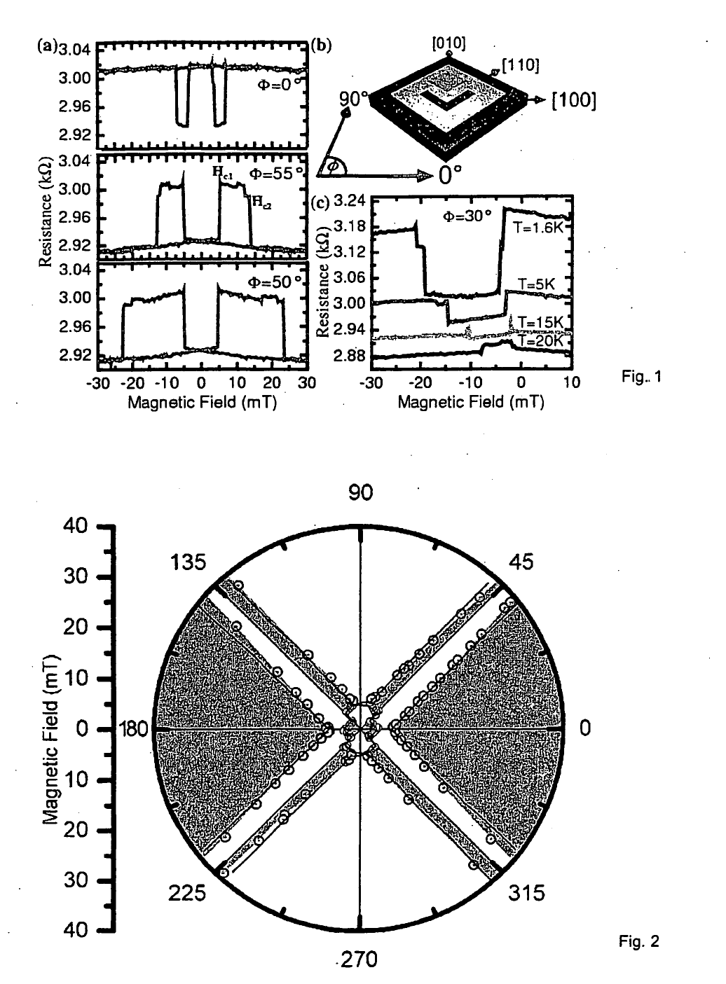

FIG. 1 to 4 show an embodiment of the invention relating to a single-sided spintronics device. The magnetic layer in our first sample is a 70 nm thick epitaxial (Ga,Mn)As film grown by low temperature (270° C.) molecular beam epitaxy onto a GaAs (001) substrate (for a discussion on the growth of (Ga,Mn)As, see for example: A. Shen, H. Ohno, F. Matsukura, Y. Sugawara, N. Akiba, T. Kuroiwa, A. Oiwa, A. Endo, S. Katsumoto, Y. Iye, J. Cryst. Growth 175/176, 1069, (1997), R. P. Campion, K. W. Edmonds, L. X. Zhao, K. Y. Wang, C. T. Foxon, B. L. Gallagher and C. R. Staddon, J. Cryst. Growth 247, 42 (2003)). High-resolution x-ray diffraction showed that the sample had high crystalline quality comparable to that of the substrate. From the measured lattice constant and the calibration curves of Schott et al. (G. M. Schott, G. Schmidt, G. Karczewski, L. W. Molenkamp, R. Jakiela, A. Barcz, G. Karczewski, Appl. Phys. Lett. 82, 4678 (2003)) the Mn concentration in the ferromagnetic layer is roughly 6%. Etch capacitance-voltage control measurements yielded a hole density estimate of ˜10²¹ cm⁻³ and the Curie temperature of 70 K was determined from SQUID measurements.

After growth, the sample was transferred to a RF sputtering system where a 1.4 mm Al layer was deposited onto the (Ga,Mn)As. The Al layer was oxidized in-situ producing a closed AlOx (aluminium oxide) layer and thereby forming a tunnel barrier. An electrical contact was then fashioned onto the structure by evaporating 5 nm of Ti as a sticking layer followed by 300 nm of Au. Standard optical lithography and chemically assisted ion beam etching (CAIBE) were then used to pattern the device as shown in FIG. 1. In the first step, material is etched away, leaving only the central 100 mm×100 mm square pillar consisting of the metal contact on a tunnel barrier. The corralling W sticking layer and Au contact are then deposited onto the (Ga,Mn)As surface, providing a back contact.

The bulk resistivity of the (Ga,Mn)As layer is 1.1×10⁻³ Wcm, consistent with expectations for high quality material (K. W. Edmonds, K. Y. Wang, R. P. Campion, A. C. Neumann, N. R. S. Farley, B. L. Gallagher, C. T. Foxon, Appl. Phys. Lett. 81, 4991 (2002)), and corresponding to a resistance of the order of 10 Ohm between the central pillar and the backside contact. This value was confirmed by measuring the resistance through similar pillars without a tunnel barrier. The resistance is over two orders of magnitude lower than that of the total device, rendering any bulk magnetoresistance of the (Ga,Mn)As fully negligible.

The sample was inserted into a variable temperature 4He cryostat fitted with 3 pairs of Helmholtz coils allowing the application of magnetic fields of up to 300 mT in any direction. For the measurements presented here, the field was kept in the plane of the magnetic layer. The direction of the field is given by its angle Á with respect to the [100] crystallographic direction, as indicated in FIG. 1b.

FIG. 1a presents typical curves of the resistance of the sample as a function of applied magnetic field at various angles, i.e. at Φ=0°, 55° and 50°. For each curve, the field is swept from negative saturation to positive saturation and back again, but the plot focuses on the region of interest from −30 to +30 mT. In all cases, the magnetoresistance exhibits spin-valve like behavior with an amplitude of about 3% delimited by two switching events (labeled H_{c1} and H_{c2} in the figure) between which the resistance of the sample is different from its value outside these events. However, the width and even the sign of the TAMR feature depend on the angle of the magnetic field. In comparing the different curves of FIG. 1a, we emphasize that despite the fact that the feature changes from negative to positive (for example, between the 0° and 55° curves in FIG. 1a), the device appears to have only two distinct resistance states; a low one of about 2920 Ohm and a high one just above 3000 Ohm.

In order to obtain a better understanding of the behavior, we summarize the data from field sweeps at many angles in the polar plot of FIG. 2. Here the open symbols represent the fields at which the switching events H_{c1} and H_{c2} occur for each of the individual sweeps. These delimit boundaries between sections of higher and lower resistance. Shaded areas indicate regions in which the sample is in its high resistance state. Viewed in this way, the loci of switching events form a highly symmetric pattern bearing a striking resemblance to switching events previously observed in magneto-optical studies of epitaxial Fe films (R. P. Cowburn, S. J. Gray, J. Ferre, J. A. C. Bland, J. Miltat, J. Appl. Phys. 78, 7210 (1995)) and (Ga,Mn)As (G. P. Moore, J. Ferre, A. Mougin, M. Moreno, L. Dwitz, J. Appl. Phys. 94, 4530 (2003)), as well as in transport studies on (Ga,Mn)As in the in-plane Hall geometry (H. X. Tang, R. K. Kawakami, D. D. Awschalom, M. L. Roukes Phys. Rev. Lett. 90, 107201 (2003)), and associated with materials that reverse their magnetization M in two steps by the nucleation and propagation of 90±domain walls. Within single-domain theory, we can write down the expression for the total magnetic energy Em of our system:

Eₘ=Kᵤ sin²(θ)+K_{c} sin²(2θ)−MH cos(θ−ø); (Equation 1)

where K_{c} is the cubic anisotropy expected to be dominant in (Ga,Mn)As (Moore et al, as above: also D. Hrabovsky, E. Vanelle, A. R. Fert, D. S. Yee, J. P. Redoules, J. Sadowski, J. Kanski, L. Ilver, Appl. Phys. Lett. 81, 2806 (2002)), while Kᵤ is the uniaxial anisotropy which is also often observed in (Ga,Mn)As (Moore et al, as above). H is the amplitude of the applied magnetic field and ø is the angle of the magnetization measured from the [100] crystal direction. Since the reversal of magnetization takes place through domain walls propagating through the structure, the picture of Stoner-Wohlfarth (E. C. Stoner, E. P. Wohlfarth, Philos. Trans. London Ser. A 240, 599 (1948)) of the coherent magnetization reversal does not apply. Instead, as discussed in Cowburn et al (see above), the magnetization will switch from its local minimum to the global energy minimum as long as the energy gained in doing so is larger than the energy required to nucleate/propagate a domain wall through the sample. Calling this energy ε, it follows from the form of Eₘ that as the magnetic field is swept (neglecting rotations away from the bi-axial easy axis at higher fields) the switching of the magnetization will take place in two steps. In the first step, M will switch from the cubic easy axis closest to the direction in which the field was initially applied to an easy axis 90± askew from this one. Then, in the second step, M will switch by an additional 90 degrees completing its full reversal. Pursuing the analysis one step further, one finds that the fields at which these switching events take place are given by, H_{c1,2}=(ε+/−Kᵤ)=(M∥cos(ø)|+/−|sin(ø)∥), where the plus (minus) sign in the denominator is for H_{c1} (H_{c2}). The sign before Kᵤ in the numerator depends on whether the switching is towards or away from a uniaxial easy axis. The sign therefore reverses every 90 degrees and is opposite for H_{c1} and N_{c2} (again, see Cowburn et al).

Fitting the above equation to our data produces the solid line in the polar plot of FIG. 2, in good agreement with experiment. This fit allows us to extract a value of about ˜450 erg/cm³ for Kᵤ and 1550 erg/cm³ for ε. We confirmed the double step switching behavior of the sample through SQUID measurements.

From this analysis and FIG. 2 it is clear that our sample is in a high resistance state when the magnetization lies along the [100] or [100] crystallographic direction, and has a lower, resistance when the magnetization is along [010] or [0Ī0]. This picture is further supported by the behavior of the magnetoresistance at higher magnetic field. When the magnetic field is not aligned along an easy axis, and the field is swept to full saturation, the magnetization will rotate away from the easy axis to the direction parallel to H. A corresponding gradual change in resistance is then observed.

We now turn to a theoretical analysis illustrating that anisotropies in the (Ga,Mn)As DOS with respect to the magnetization orientation are large enough to explain the observation of this spin-valve like effect. The electronic structure of the (Ga,Mn)As is calculated using the k.p envelope function description of the GaAs host valence bands in the presence of an effective exchange field, h=J_{pd} S_{Mn}, produced by the polarized Mn local moments with spin density S_{Mn} (see J. KÁonig, J. Schliemann, T. Jungwirth, and A. H. MacDonald, in Electronic Structure and Magnetism of Complex Materials, edited by D. J. Singh and D. A. Papaconstantopoulos (Springer Verlag, Berlin, (2003)). The broken in-plane cubic symmetry responsible for the difference between tunnel resistances for magnetization along [100] and [010] is theoretically modeled by introducing an in-plane uniaxial strain of order 0.1%. Due to a very strong spin-orbit interaction in the valence band, such a small strain leads to values of Kᵤ comparable to the one estimated above and also to sizable DOS anisotropies.

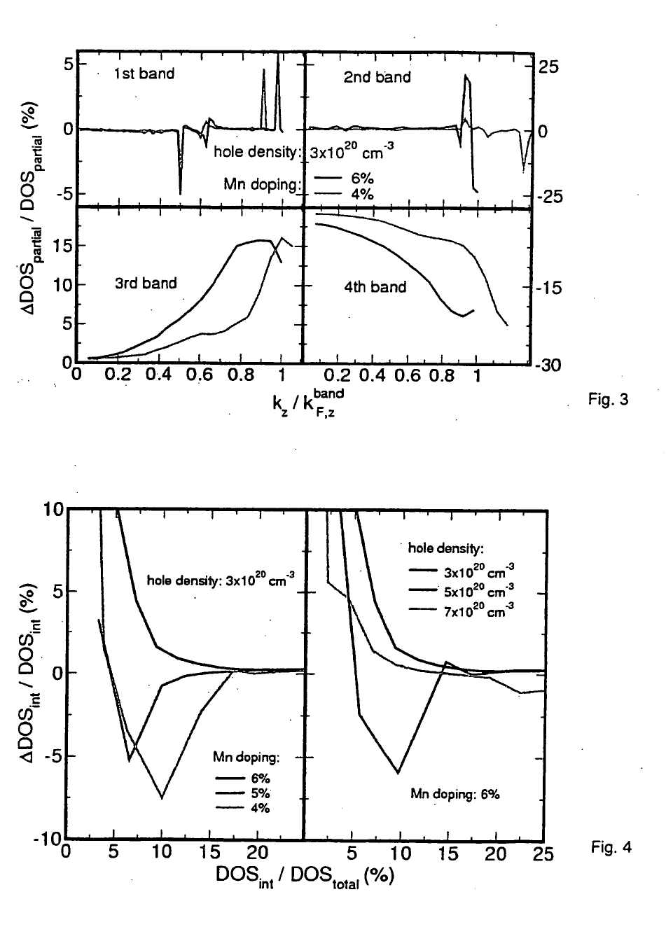

Defining the partial DOS as the DOS at a given kz and for a given band, we show in FIG. 3 the relative partial DOS anisotropy (ΔDOSₚₐᵣₜᵢₐₗ is equivalent to DOSₚₐᵣₜᵢₐₗ (M∥[010])−DOSₚₐᵣₜᵢₐₗ(M∥[100])) at the Fermi energy calculated as a function of the out-of-plane wavevector k_{z} for each of the four occupied bands that derive from the GaAs heavy- and light-hole states which are spin-split due the presence of the Mn-moment induced exchange field. k^{band}_{F,z} is the Fermi wavevector in the given band for MnGa concentration of 6%.

Note that the experimental Curie temperature of 70 K is reproduced theoretically assuming the hole density 3×10²⁰ nm⁻³ and 4% of the cation sites occupied by Mn, which is reasonably consistent with the experimental concentration estimates. The total DOS (DOSₜₒₜₐₗ) obtained by integrating over all k_{z} up to the Fermi wavevector k_{P,z} and summing over all bands, has an anisotropy at the Fermi energy of less than 1% with respect to the magnetization orientation. The tunnel conductance is, however, proportional to the DOSₜₒₜₐₗ only if in-plane momentum is not conserved during the tunneling. For cleaner barriers and interfaces, in-plane momentum is at least partially conserved resulting in, roughly speaking, a higher probability of tunneling for states with higher band and k_{z} indices. As demonstrated in FIG. 3, the DOSₚₐᵣₜᵢₐₗ of these states can change by tens of percent upon magnetization reorientation. FIG. 3 also suggests that the magnitude and even the sign of the overall tunnel magnetoresistance effect depends on parameters of the (Ga,Mn)As film, such as the density of local spins on substitutional Mn impurities, or on the barrier and interface character which may select different ranges of band and k_{z} states that dominate the tunneling current.

To estimate the overall size of the magnetoresistance effect produced by the (Ga,Mn)As DOSₚₐᵣₜᵢₐₗ anisotropy we start with the assumption that for clean barriers (perfect in-plane momentum conservation) the tunneling is dominated by states in the (Ga,Mn)As with kz close to the Fermi wavevector in each band and that the tunneling probability of these states is independent of the band index. We then gradually relax the momentum conservation condition by adding states at the Fermi energy with decreasing k_{z}. In FIG. 4 we plot the relative difference between this integrated DOSᵢₙₜ (integrated over the assumed range of k_{z} contributing to tunneling and summed over the four occupied bands) for the two magnetization orientations. For ˜10% of the total DOS at the Fermi energy participating in the tunneling process, the theoretical DOSᵢₙₜ anisotropy is clearly consistent with the experimentally observed TAMR of order several percent.

The curves in the left panel of FIG. 4 are labeled by different Mn doping concentrations and illustrate the general dependence of the magnetoresistance effect on the Mn local spin density. On a mean-field level this can be understood by recalling that the (Ga,Mn)As electronic structure depends only on the overall value of the effective exchange field h=J_{pd}S_{Mn}, whether the spin-density magnitude |S_{Mn}| changes through varying the number of Mn impurities at a fixed temperature or through the temperature-dependent average spin polarization of an individual Mn local moment at a fixed doping level. The data in the left panel of FIG. 4 therefore suggest that the sign of the tunnel magnetoresistance effect can change with temperature. We emphasize that this change in sign occurs without a change of sign of the uniaxial anisotropy energy constant. The right panel in FIG. 4 also predicts a strong dependence of the TAMR on the number of holes in the (Ga,Mn)As valence band.

In our sample the Mn doping and hole density are obviously fixed. The temperature dependence, however, can be tested and the experiment confirms the change of sign seen in the above theoretical curves. FIG. 1c shows a series of magnetoresistance curves along 30° for temperatures ranging from 1.6 to 20 K. At 1.6 K, the TAMR signal is clearly negative. Its amplitude gradually decreases to zero by 15 K, changes sign and grows again as temperature is raised to 20 K. In fact, we find that as temperature is increased from 4 K to 20 K, the entire polar plot reverses signs. Since the sign of Kᵤ does not change with temperature, this is an experimental confirmation that the transport and magnetic anisotropies can vary independently in our system.

The TAMR studied here shows a rich phenomenology that opens new directions in spintronics research. Avoiding the second ferromagnetic layer may have fundamental consequences for the operation at high temperatures. It has been shown that in structures of the (Ga,Mn)As/(Al,Ga)As/(Ga,Mn)As type the ferromagnetic layer which is buried inside the heterostructure cannot be effectively treated by post-growth annealing procedures and hence retains its relatively poor as-grown magnetic quality (see D. Chiba, K. Takamura, F. Matsukura, and H. Ohno, Appl. Phys. Lett. 82, 3020 (2003)). Our design suggests possible operation at temperatures limited by the transition temperature achieved in (Ga,Mn)As or related ferromagnetic semiconductors, which has been steadily increasing over the past two years. The data also demonstrate that the sense of the spin-valve like signal, i.e., whether a high- or low-resistance state is realized at saturation, can change with the angle at which magnetic field is applied, with temperature, or structural parameters of the (Ga,Mn)As layer, interfaces, and the tunnel barrier.

Last but not least, our experiments provide a new perspective on tunnel magnetoresistance in structures with two ferromagnetic contacts. We demonstrate the need for caution in analyzing spin-valve experiments, especially in materials where strong spin-orbit coupling is present. As we have seen here, the existence of a spin-valve like signal does not automatically imply the emission and detection of a spin-polarized current in the tunneling structure. On the other hand two distinct material properties combined in a constructive way can lead to bistable magnetoresistive devices with unprecedented properties. We also note that the amplitude of the effect discussed here may be further optimized by using barriers with greater degrees of momentum conservation such as, for example, epitaxial AlAs.

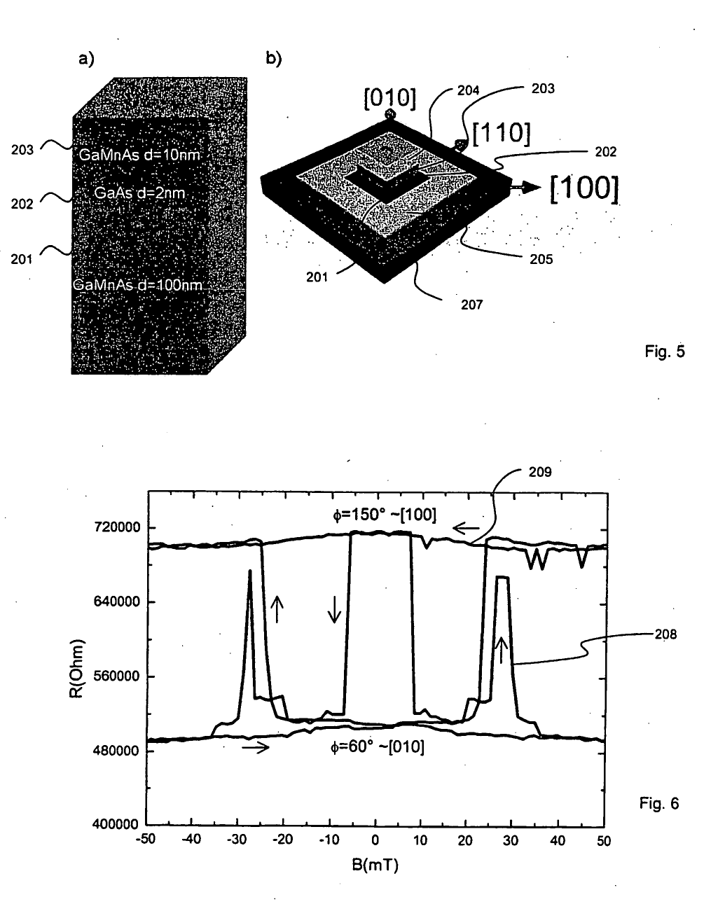

The system shown in FIG. 1 to 4 and described above has one definite coordinate system. The system shown in FIG. 5 to 16 and described below has a different definite coordinate system. The two systems are rotated by about 150 degrees with respect to one another.

A device with a very large tunneling anisotropic magnetoresistance in a double sided ferromagnetic semiconductor tunnel junction is shown in FIG. 5 illustrating the layer structure used for the magnetic tunnel junction, as prepared by low temperature molecular beam epitaxy (LT-MBE). A Ga₁₋ₓMnₓAs (x=6%, d=100 nm) (reference numeral 201)/undoped GaAs (thickness 2 nm; reference numeral 202)/Ga₁₋ₓMnₓAs (x=6%, d=10 nm, reference numeral 203) trilayer structure was grown on top of semi-insulating GaAs substrate (reference numeral 207) and an undoped LT-GaAs buffer layer (120 nm; reference numeral 201). The ferromagnetic transition temperature Tc of the (Ga,Mn)As layers is 65K. FIG. 5b shows a schematic of the final transport device with a sample layout and contact pads. Using optical lithography with positive photoresist followed by metal evaporation and lift-off, the heterostructure was patterned into an inner square contact mesa 204 with sides of 100 μm and a surrounding electrical back contact 205. The top of the square mesa 204 (Ti-Au-contact) contacts the upper 10 nm thick (Ga,Mn)As layer 203, whereas the back contact 205 adheres to the lower 100 nm thick (Ga,Mn)As layer 207. This sample structure makes it possible to perform two-probe magnetoresistance measurements through both ferromagnets and the GaAs tunnel barrier. The resistance of the device is fully dominated by the vertical tunneling process through the tunnel barrier: identically patterned control samples without a tunnel barrier have a resistance of the order of 10 Ohm, whereas the sample which exhibits the tunneling anisotropic magnetoresistance effect has a resistance of approximately 500 kOhm in its low resistance state at T=4.2K. This renders any contributions coming from the bulk magnetoresistance of (Ga,Mn)As fully negligible.

Two-probe MR measurements are then performed for current flowing vertically through the layer stack. Since the bulk resistivity of the (Ga,Mn)As is only ˜10⁻³ Ohm*cm, the device resistance is dominated by the tunnel barrier. Identically patterned control samples without a tunnel barrier have a resistance of 10 Ohm proving that any bulk (Ga,Mn)As MR is fully negligible.

Transport measurements were carried out in a magnetocryostat fitted with a variable temperature insert and a set of three mutually orthogonal magnet coils. They allow for the application of magnetic fields of up to 300 mT in any direction. Fields applied in the plane of the multilayer are denoted by the angle φ, with φ=0° being the direction of the magnetic field of the X-coil of the magnet. Two different types of experiments were carried out on the sample. Firstly, the measurement of the magnetoresistance is performed by saturating the sample magnetization at an angle φ=0° and then measuring the resistance of the device as the magnetic field magnitude H is swept up or down at constant angle φ₀. The second type of experiment is a T-scan and consists of measuring the resistance while sweeping the magnetic field angle φ at a constant magnitude H₀.

FIG. 6 shows plots of the magnetoresistance taken at a bias of 10 mV and T=4.2K. The measurements were taken with the magnetic field applied along the [100] and [010] crystal directions. These directions are the magnetic easy axes in the sample, as verified by SQUID magnetometry. Also, a number of groups in the field report the same magnetic anisotropy for similar (Ga,Mn)As layers as Moore, G. P., Ferré, J., Mougin, A., Moreno, M. and Dāwitz, L. “Magnetic anisotropy and switching process in diluted Ga₁₋ₓMnₓAs magnetic semiconductor films” in J. Appl. Phys. 94, page 4530 (2003) and Hrabovsky, D., Vanelle, E., Fert, A. R., Yee, D. S., Redoules, J. P., Sadowski, J., Kanski, J., Ilver, L. “Magnetization reversal in GaMnAs layers studied by Kerr effect” in Appl. Phys. Lett; 81, 2806 (2002).

For each orientation, the field was swept from positive to negative saturation and back, producing hysteretically symmetric curves. One direction for 60° has received arrows and the reference numeral 208 and one direction for 150° has received arrows and the reference numeral 209. For both curves and in fields bigger than 30 mT, the resistance of the device exhibits only gradual changes caused by a rotation of the magnetization of the two layers between the applied field and the respective easy axes. At lower fields and after crossing zero, the magnetization reverses its direction abruptly by the formation of domain walls. In the transport data this manifests itself as well defined changes in resistance. An important aspect is that, although the magnetoresistance is spin valve-like with a signal change of ˜30% to 40%, it can be both positive and negative. This clearly distinguishes our findings from previous reports of what was interpreted as tunneling magnetoresistance (TMR) in comparable (Ga,Mn)As based structures as reported by Tanaka, M., Higo, Y., Large Tunneling Magnetoresistance in GaMnAs/AlAs/GaMnAs Ferromagnetic Semiconductor Tunnel Junctions. Phys. Rev. Lett. 87, 026602 (2001).

FIG. 6 shows MR-scans taken with a voltage bias V=10 mV at a temperature T=4.2 K along 60° (numeral 208) and 150° (numeral 209), near the two cubic magnetic easy axes in the (Ga,Mn)As ([100] and [010] respectively) as verified by SQUID. At low |H| after crossing zero in either sweep directions, M abruptly reverses its direction. This manifests itself in transport as a discontinuous change in resistance leading to a 40% spin-valve signal. The measurement along 60° appears similar to previous observations, and could easily be mistaken for traditional TMR. However, the remarkable sign change observed at 150° points to a different origin of the effect, and strongly suggests an interpretation in line with observations of TAMR in single-ferromagnet devices.

As we apply |H| at other angles in the plane, the amplitude of the effect remains constant whereas the position and sign of the sharp switching events displays a strong angular dependence, with an underlying symmetry consistent with the one for a single magnetic layer device. Neglecting some fine structure in the shape of the peaks, the relatively straightforward picture of the two step magnetization reversal accounts for this low |H| symmetry. It comes from a combination of the magnetic anisotropy of the (Ga,Mn)As, which is principally cubic with a small in-plane uniaxial contribution, and the fact that magnetic reversal takes place via 60° domain wall nucleation and propagation. At low fields, rather than a coherent rotation of the magnetization, the dominating reversal mechanism consists of the magnetization switching abruptly whenever the energy gain by doing so is greater than the energy needed to nucleate/propagate a domain wall.

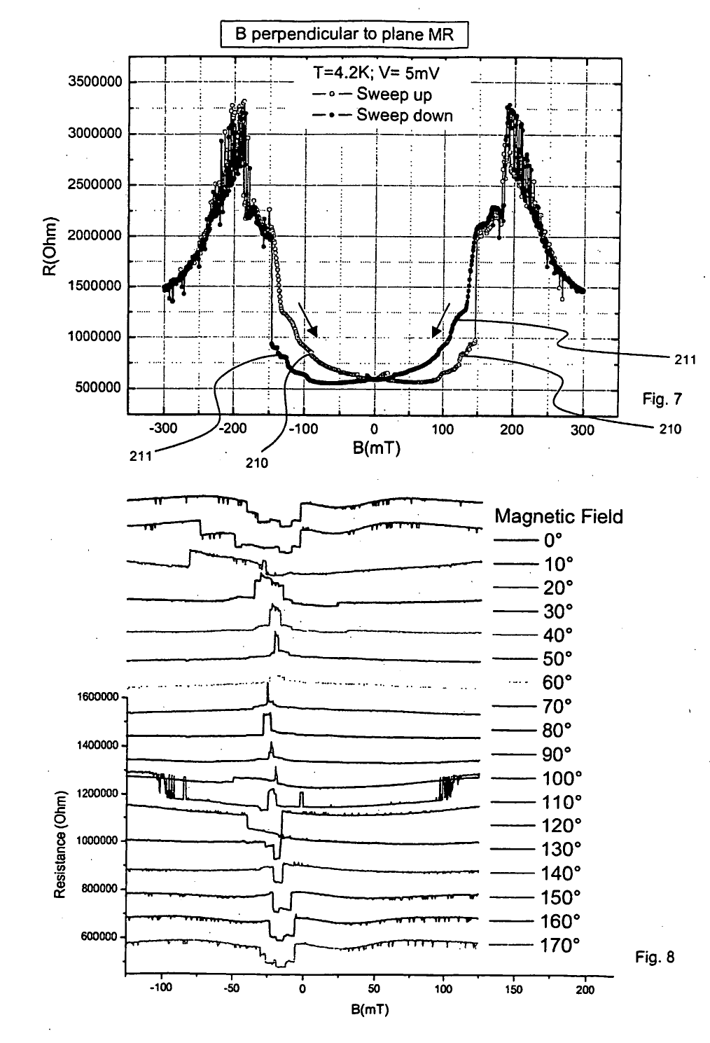

Another important difference is a very strong magnetoresistance when the magnetic field is applied perpendicular to the plane of the sample, i.e. along the magnetic hard axis. A corresponding measurement at T=4.2 K with an excitation voltage of V=5 mV is depicted in FIG. 7. In comparison with H in plane measurements, the magnetoresistance curve confirms a very strong in plane anisotropy of the two magnetic layers. The maximum resistance change at this bias is about 600%. Remarkably this value is even larger than the corresponding features with the same excitation voltage and the magnetic field applied in the plane of the sample. The sweep-up curve has received the reference numeral 210 and the sweep-down curve the reference numeral 211. When the magnetic field is applied in plane at an angle farther away from the two mutually perpendicular easy axes, the magnitude of the effect remains roughly constant, whereas the location of the sharp switching events displays a strong angular dependence which is evidenced in FIG. 8. Here, the magnetic field was applied in the plane of the sample, at angles ranging from 0° to 170° in steps of 10°. For better clarity, the individual magnetoresistance curves are offset vertically. The magnetic easy axes are at ˜60° and ˜150° and from the plot it is clear that minima of the coercive field are present at these angles. For fields farther away from the easy axes, the transport features become broader. The maximum coercive fields are present at ˜20° and ˜110° respectively, close to the directions along the edges of the sample. These are also the directions exhibiting the strongest continuous variation of the sample resistance which can be ascribed to a Stoner Wohlfarth like coherent rotation of one or both of the layers.

In general, at any given field angle, a large number of step-like features are present. Despite this richness of features, the main features can be understood by a relatively straightforward picture of the magnetization reversal. It is known from literature as from Moore, G. P., Perre, J., Mougin, A., Moreno, M. & Dewitz, L. in “Magnetic anisotropy and switching process in diluted Ga₁₋ₓMnₓAs magnetic semiconductor films” in J. Appl. Phys. 94, 4530 (2003) or from Hrabovsky, D., Vanelle, E., Fert, A. R., Yee, D. S., Redoules, J. P., Sadowski, J., Kanski, J., Ilver, L. in “Magnetization reversal in GaMnAs layers studied by Kerr effect” in Appl. Phys. Lett. 81, 2806 (2002) and from our SQUID and magnetotransport measurements of single (Ga,Mn)As layers that this and similar (Ga,Mn)As layers have anisotropy consisting of a cubic plus a smaller uniaxial contribution along the [100] and [010] axes. The expression for the total magnetic energy Eₘ of a single domain then becomes

Eₘ=Kᵤ sin²(θ)+K_{c} sin²(2θ)−MH cos(θ−ø); (Equation 1)

where K_{c} is the cubic and Kᵤ the uniaxial anisotropy constant. H is the amplitude of the applied magnetic field and q the angle of the magnetization measured from the [100] crystal direction. It is clear from our data that at low fields a coherent rotation of the magnetization is not the dominating mechanism of magnetization reversal. At these field levels, domain walls play a role. The magnetization switches from a local energy minimum to a global one whenever the energy gain by doing so is bigger than the energy needed to nucleate/propagate a domain wall. Depending on where the global energy minimum lies with respect to the current magnetization direction, the domain wall can be a 90° or 180° domain wall.

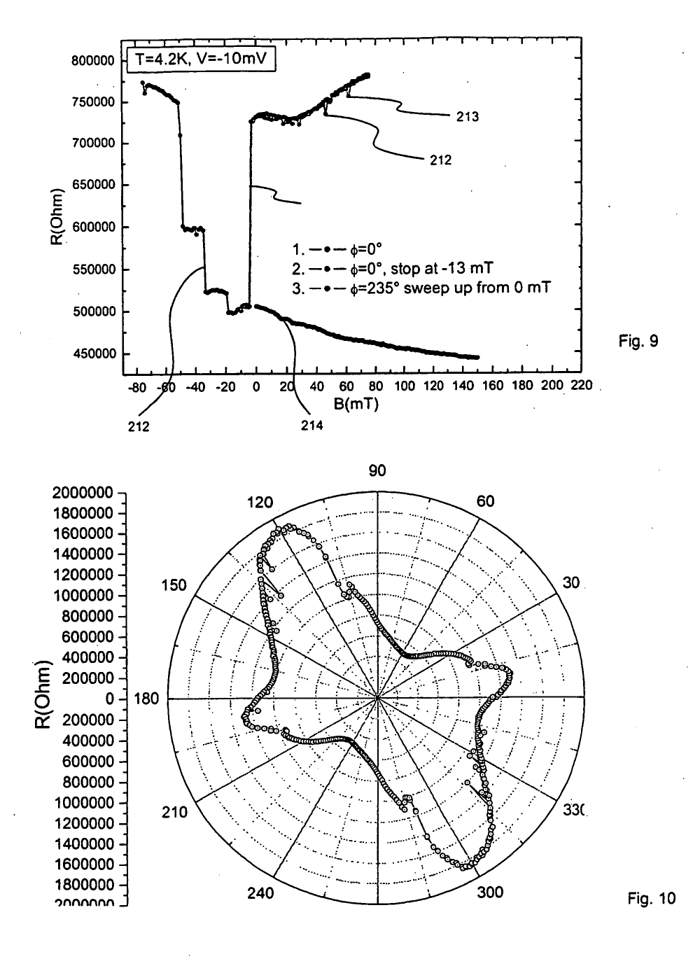

By measuring appropriate minor loops of the magnetoresistance we can show that both layers have their uniaxial easy axis close to φ=60°, the second and slightly less easy axis is along 150°. Typical data is shown in FIG. 9. The dotted black curve 212 was taken first while sweeping down from positive to negative saturation along φ=0°. It was assumed that the first and biggest jump in the resistance data is due to both layers transitioning from the closest cubic easy axis (φ=330°) to the uniaxial easy direction along φ=235°. This was tested by measuring the further dotted curve 213 only to ˜(−13 mT), stopping the magnetic field after the first jump. Then the magnetic field was swept back to zero along 0° and then raised again along φ=235°. It can be seen that except a gradual decrease of the resistance along the additional curve 214, no abrupt jumps occur up to 150 mT, which is proof that the magnetization already was already lying along this direction. Similar experiments have shown that the upper resistance level of ˜750 kOhm is associated with both magnetic layers being magnetized along the slightly weaker easy axis at ˜150°.

The minor loops show that the magnetic anisotropy is closely associated with a transport/resistance anisotropy inherent to the device. From FIG. 6 one can see that both layers having M∥[100] is equivalent to a high resistance state of ˜700 kOhm and if their M∥[010], this corresponds to a resistance of ˜48° kOhm. This is a unique aspect of our device, since in contrast to regular spin valves which are described within the model of Jullière M. in “Tunneling between ferromagnetic films”, Phys. Lett. 54A, 225-226. (1975), our sample represents a magnetic field sensor which is truly sensitive to the absolute directions of the magnetizations of the layers and not only to their relative orientation (parallel/antiparallel). This characteristic is demonstrated in FIG. 10. In this φ-scan, at T=4.2 K and V=5 mV, the magnetic field amplitude |H| is kept constantly at 300 mT, while its direction is swept the counter clockwise. The measurement is identical for clockwise or counter clockwise sweeps with |H| sufficiently large to saturate M. The graph represents the resistance of the device plotted against the direction of the applied field. Due to the high external magnetic field, it can be safely assumed that the magnetizations of the two layers are approximately collinear. The data yields the unexpected result that there is a variation of more than 300% between the lowest resistance at ˜60° and the highest resistance at 120°.

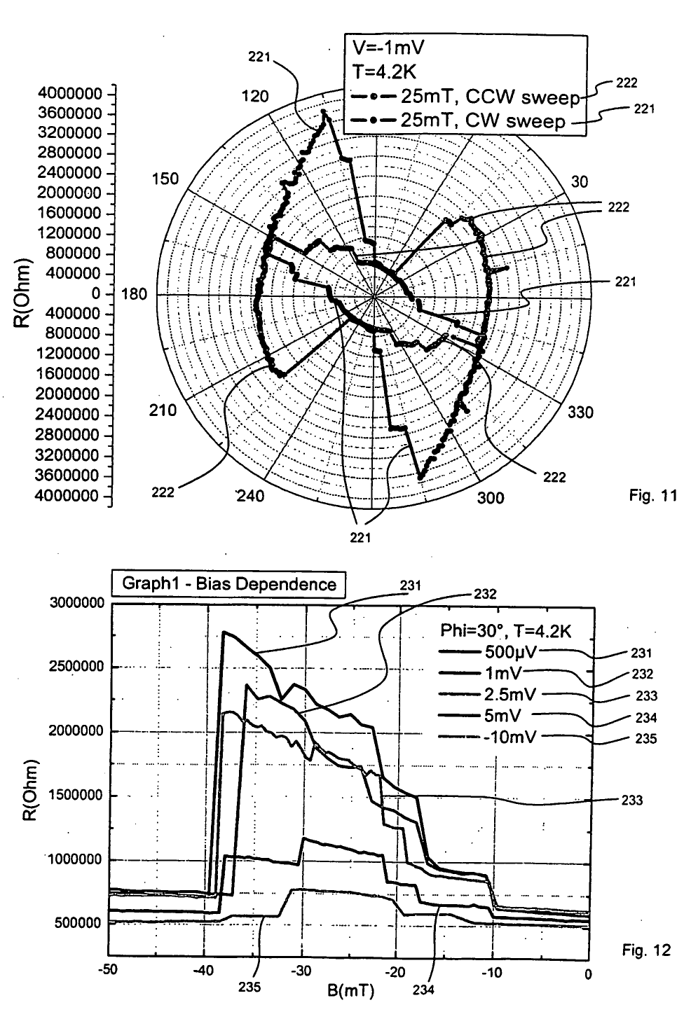

The appearance of the T-scan changes dramatically with the magnitude of the applied field. This is demonstrated in FIG. 11 where the magnetic field was carefully chosen to be slightly higher than the highest field needed along any direction for a 90° switch of the magnetization. First, the magnetization was saturated along the negative uniaxial easy axis, φ=240°. Then the magnetic field was lowered to H=25 mT and swept in the clockwise (first curve 221) and counter clockwise direction (second curve 222).

The main features of the data are ˜40% jumps in the resistance levels. These can be explained rather simply by noting that at φ=90° the sample is in a low resistance state associated with M being along the [010] easy axis. As φ is swept nearer to the [100] easy axis, M will eventually switch to this direction, corresponding to a high resistance state due to the additional uniaxialeld that breaks the in-plane cubic symmetry in the (Ga,Mn)As layers. The curves must be different for the two sweep directions as they should have approximate mirror symmetry about the easy axis. The deviations from this symmetry can be attributed to non-uniform strain distributions.

Several characteristic resistance levels are present in the data which are situated between the minimum and maximum resistances, corresponding with the magnetization of the layers being completely along the easy axes. The existence of the various intermediate states can be explained in a straightforward way. By design, the magnetic anisotropies of the two layers are not identical. Slightly different strain conditions and the different thickness of the layers create slightly different coercive fields. Thus, as the magnetic field is rotated in the plane, the layers do not switch simultaneously. The softer of the two will switch earlier. This creates configurations where the relative angle between the magnets is not zero as in the 300 mT T-scan but 900 or 180°, for example. Since all of these configurations have different resistances, a spin valve like behaviour of the sample is seen in a revolving magnetic field as well as in regular magnetoresistance measurements. As a control experiment, a similar φ-scan at H=15 mT was also conducted. As expected, since 15 mT is too low a field to switch either of the layers at any field direction, the resistance of the sample remained constantly at its lowest value. This unique behaviour opens up novel design perspectives for spin valves which can be programmed in rotating magnetic fields above a certain threshold magnitude, but not below.

The size of the spin valve like signal of the tunnel junction exhibits a very strong voltage dependence, which is displayed in FIG. 12. The various curves are magnetoresistance measurements taken along φ=30° at a temperature of 4.2K. The excitation voltage ranges from 500 μV up to 10 mV (curves 231, 232, 233, 234 and 235). The low resistance state exhibits a relatively low variation, increasing from 500 kOhm to about 750 kOhm with decreasing bias. In contrast, the high resistance value increases by more than 350% in the same voltage range. Similar values apply for φ-scans at different biases.

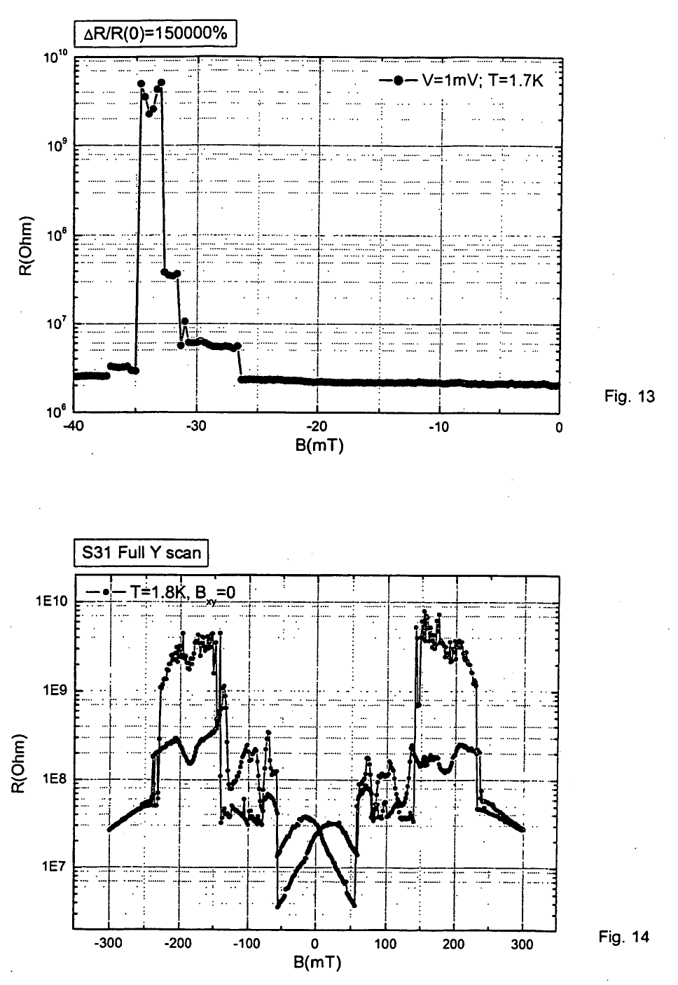

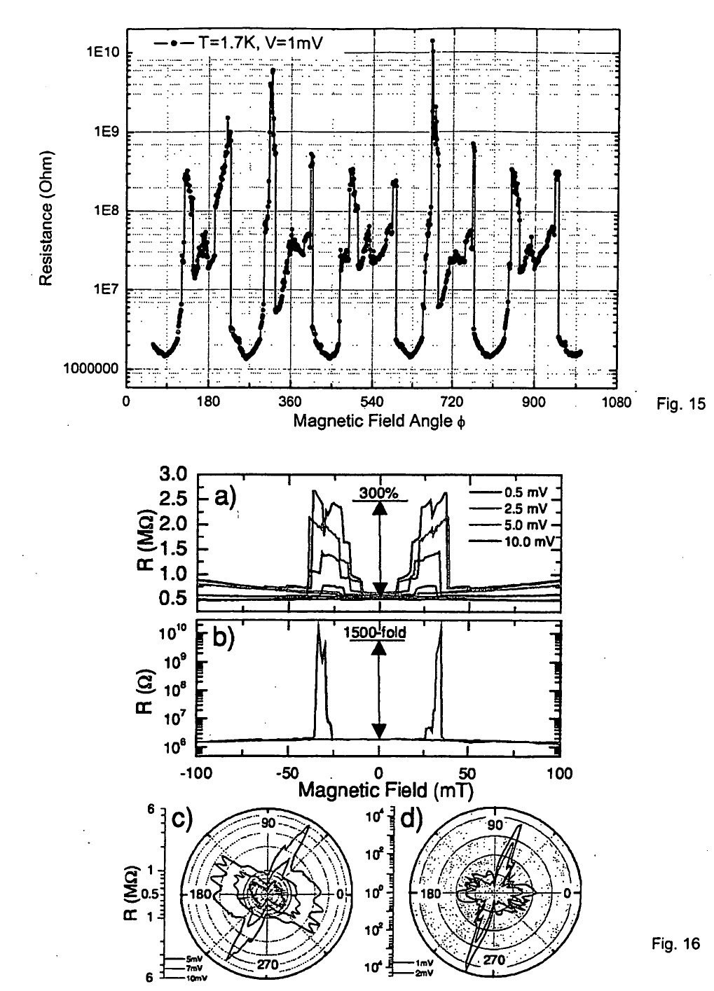

FIG. 13, FIG. 4 and FIG. 15 illustrate the consequences of decreasing temperatures on magnetoresistance and φ-scan measurements. From this data it is obvious that the magnitude of the features is extremely temperature-sensitive. A temperature decrease to T=1.7K causes the effect to increase to 150000%, as depicted in the φ=60° magnetoresistance curve in FIG. 13. Although it is much bigger due to both lower bias and temperature, the effect is still qualitatively the same as in the corresponding curve in FIG. 6. Additional measurements show that when temperature or bias are lowered even more, the feature size still increases. However, when doing so, it becomes more and more difficult to resolve the high resistance levels which approach 1010 Ohm. 150000% is thus just a lower limit for the magnitude of our effect, as we are limited by the experimental setup.

FIG. 16 shows the amplification of the effect at low bias voltage and temperatures, wherein a) TAMR along φ=30° at 4.2 K for various bias voltages, b) super-giant TAMR at 1.7 K and 1 mV bias, c) and d) φ at various bias at 1.7 K showing that at low bias and temperatures, TAMR probes the detailed anisotropies of the density of states.

Another prominent characteristic of our device is the very strong V dependence of the signal displayed in FIG. 16a. The various curves show the magnetoresistance along φ=65° at T=4.2 K with V ranging from 500 mikrovolt up to 10 mV. The low resistance state has a relatively small variation of ˜20% with decreasing bias. In contrast, the high resistance state increases by more than 250%. The amplitude of the TAMR effect is also very sensitive to T, as shown in FIG. 16b. Here we compare V=1 mV curves at 4 and 1.7 K where the effect increases to 150000%. Indeed, this is merely a lower limit corresponding to the detection limit of the amplifier used. Although the amplitude of the effect increases dramatically at low V and T, the general symmetry remains unchanged indicating that the origin of the effect is unchanged, but that it is amplified by an additional mechanism.

This super-giant amplification of the TAMR can be understood as a manifestation of a well known zero bias anomaly in tunneling from a dirty metal which appears due to the opening of an Efros-Shklovskii gap at E_{F} when crossing the metal-insulator transition. Indeed, such an effect should be observed in our device given the short (Ga,Mn)As mean free path of a few Angstrom which limits the injector region to a very thin layer near the barrier. Depletion near the barrier must therefore cause a lower carrier density in the injector region than in the bulk of the (Ga,Mn)As slab. The injector will therefore be much closer to the metal-insulator transition than a typical (Ga,Mn)As layer. Moreover, we already know that the DOS changes with M. Therefore, when we per-form experiments at low V and T, the effective DOS participating in the tunneling can be brought through the metal-insulator transition with reorientation of M, leading to a large amplification of the TAMR effect. A further indication that the Efros-Shklovskii gap is the dominant enhancing mechanism is that the amplification of the effect as T changes from 4.2 K to 1.7 K is strong for low bias voltage (1 mV), but disappears at higher voltages (10 mV), consistent with tunneling experiments near the metal-insulator transition of Si:B. Other possible mechanisms for the enhancement of the TAMR, such as disorder and impurity mediated tunneling, may also play a role and should not be summarily dismissed.

Finally, in FIGS. 16c and 16d φ-scans at 1.7 K for various V are shown, which demonstrate another important aspect of the device which is that it acts as a detector for the anisotropies in the DOS of the (Ga,Mn)As layer. FIG. 16c already shows some fine structure, which becomes much more pronounced at lower the bias. This is to be expected as we start detecting fine structure in the anisotropy of the DOS, which should be complex given that the opening of the gap should develop differently for the various bands which have different effective masses.

In summary, a super-giant TAMR effect in a (Ga,Mn)As/GaAs/(Ga,Mn)As tunnel structure had been observed which can be of order of a few hundred % at 4K, and can be amplified to 150 000% at lower temperatures. The behavior of the structure not only mimics normal TMR when the field is applied along the [010] direction, but also exhibits new functionalities such as a sensitivity to not only the amplitude, but also to the direction of an applied magnetic field. While many of the experimental features of this novel effect can be understood through the one-particle tunneling DOS anisotropies with respect to the magnetization orientation, the dramatic amplification at low biases and temperatures poses new challenging questions for the theory of tunneling transport in disordered interacting electronic systems with strong spin-orbit interaction.

Using tunneling between two layers which have density of states that depend on the direction of their magnetization, we demonstrate new functionalities for semiconducting spin valve devices. These functionalities include effects surpassing 100000% in amplitude as well as sensitivity not only to the relative orientation of the magnetizations, but also to their absolute orientation and therewith to the direction of an external magnetic field.

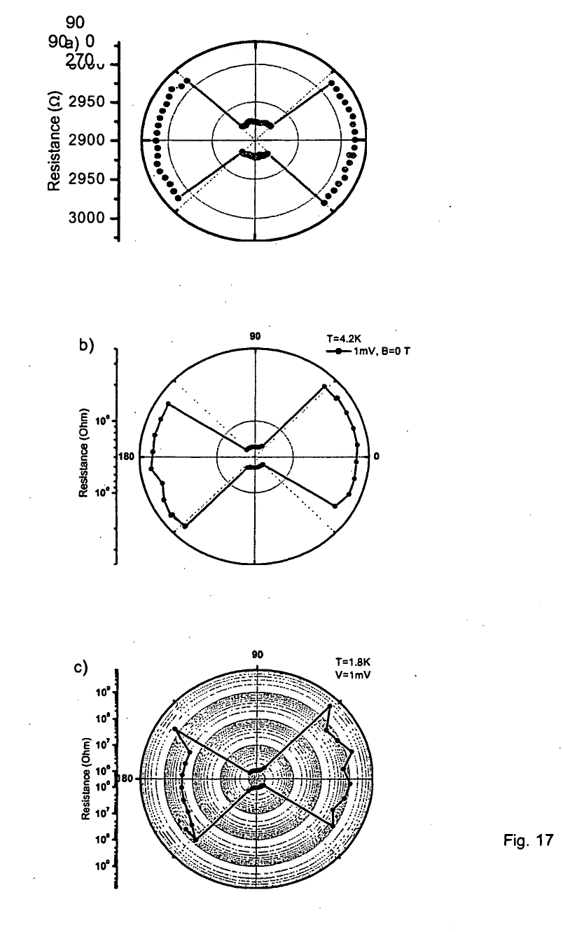

FIG. 17 shows sample resistance at 0 mT, after saturating M at an angle φ. The step function behavior of the measurement makes it possible to write information to the TAMR device with an external magnetic field and later read it by measuring the resistance of the device. The data shown her is measured on the Au/AlOx/(Ga,Mn)As sample at T=4.2K (a) and the (Ga,Mn)As/GaAs/(Ga,Mn)As sample at T=4.2K (b) and T=1.8K (c). Therefore this Fig. relates to a Read/Write of Memory Element and/or Programmability of TAMR sensor by an external magnetic field. It has to be noted that in the following text the angle φ is defined such that 0° lies along the [100] crystal direction.

In TAMR, there is a direct correlation between the absolute orientation of the magnetization M of each ferromagnetic layer in the sample and its resistance. This can be employed in various ways to construct a sensor for an external magnetic field or to store information in a TAMR based device, for example. The sensor and storage principles can be the same, irrespective of the total number of ferromagnetic layers in the TAMR device. The data in FIG. 17 is a plot of the sample resistance at a magnetic field B=0 mT measured after saturating the magnetization M along an angle φ. Both the single ferromagnet TAMR sample (FIG. 17a) as well as the double ferromagnet TAMR sample (FIGS. 17b, 17c) show qualitatively similar features in this kind of experiment. The figures display the resistance of the sample along the angle φ that was been used to prepare the magnetic state. The most prominent feature in all plots is that there are distinct steps separating a low and a high resistance state. In the case of the (Ga,Mn)As/GaAs/(Ga,Mn)As sample, this is true both for the regular TAMR in the 4.2K measurement (FIG. 17b) but also for the super-giant TAMR which occurs at lower temperatures (T=1.8K, FIG. 17c).

The mechanism behind the step-like behavior can be explained by using our TAMR model. When the magnetic field is very high and points along an angle φ, the magnetization aligns along the field. When the field is lowered to zero, the magnetization settles along one of the easy axes. In an interval around the 90° direction for example, the [010] easy axis is preferred, whereas in an interval around 0°, the magnetization relaxes to the [100] easy axis. This explains the occurrence of the two main resistance levels in these measurements.

This characteristic of the sample can be employed to construct a memory cell. First, the information (e.g. high R equals “1” and low R equals “0”) can be written into the cell by switching the magnetization along an appropriate direction, using an external magnetic field for example. Then, at zero external field, the information can be read by measuring the resistance of the device.

The fabrication of the devices described within this patent required breaking of the symmetry, and thereby creation of a magnetic anisotropy in the ferromagnetic layer to provide for the observation of different resistance states when the magnetization vector is aligned along various crystallographic directions. Moreover, the detailed behavior of the devices depends on the magnetization reversal process itself. We propose that both the magnetic anisotropy and the magnetization reversal process can be controlled by details of the underlying substrate and buffer layer as well as by an over-layer.

For a material with cubic symmetry, which has a symmetry between the [100], [010], and [001] crystallographic direction. It is well known that symmetry is broken between the [001] growth direction and the plane containing the [100] and [010] direction due to strain arising from growth on under-layers which are not perfectly latticed matched to the object layer. The [100] and [010] directions are however general equivalent.

In order to create anisotropy between the [100] and [010], the in-plane fourfold symmetry must be broken. Three methods of achieving such a breaking of symmetry are:

A Starting growth on a substrate which is slightly miss-cut with respect to its nominal principal lattice direction, and thus breaking the system symmetry.
B Proper selection of the buffer layer.
C The use of an over-layer.

In addition to a breaking of the in-plane fourfold symmetry, in order to achieve sharp switching of the resistance states between the various crystallographic directions during magnetoresistance scans, a discontinuous change in the magnetization direction, as opposed to a slow and continuous rotation, is required. This can be achieved by creating conditions favoring the modification of the macroscopic magnetization state through the nucleation and propagation of a domain wall, instead of through a coherent rotation. Again, the same three methods as listed above may be independently, or jointly, used, to achieve such switching, as all 3 act to break the overall symmetry of the layer, and to create nucleation seeds favoring the formation of domain walls.

In the following text, we show experimental results on the investigation of the role of each of the above listed factors on the magnetic anisotropy and the magnetization reorientation process of the ferromagnetic layers.

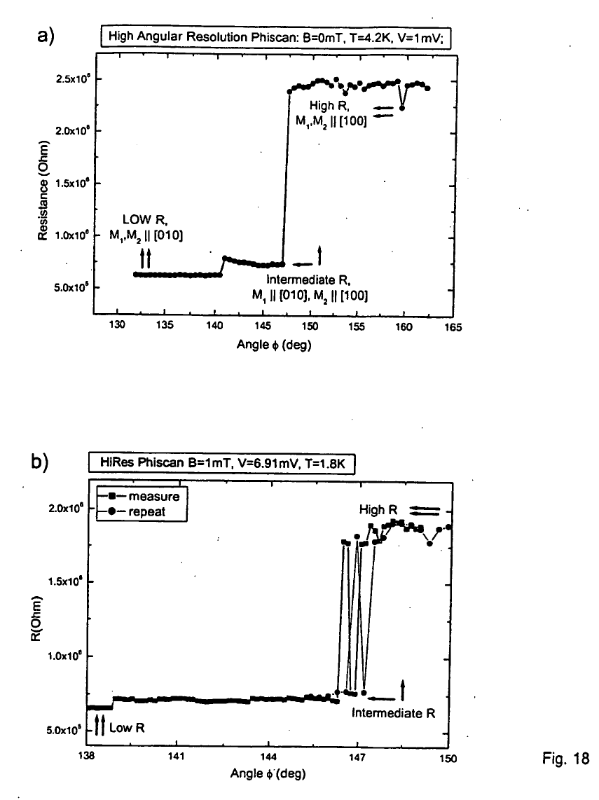

FIG. 18 shows high angular resolution φ-scans (B=0 mT) measured in the transition region between the high and the low resistance state. The measurements show the existence of an intermediate resistance state at T=4.2K (a) and T=1.BK (b). In this state the angle between the two magnetizations is 90°. FIG. 18 therefore demonstrates the existence of a magnetic state characterized by a 90° angle between the magnetizations of the two (Ga,Mn)As layers.

A closer inspection of the transition regions between the high and low states in FIG. 17b and FIG. 17c for the (Ga,Mn)As/GaAs/(Ga,Mn)As sample reveals the existence of small interval where the sample is in an intermediate resistance level. This is shown by the high angular resolution φ-scans displayed in FIG. 18a (T=4.2K) and FIG. 18b (T=1.8K). The interpretation of the intermediate state is that in this angular interval, one of the two layers relaxes into the high resistance [100] direction whereas the other one, with slightly different magnetocrystalline anisotropies for example, prefers to align along the low resistance [010] direction. In this case there is an angle of 90° between the two magnetization vectors. Above and below the transition region, the two magnetizations are colinear.

The low temperature measurement in FIG. 18b shows another interesting property of the 90° state. When the same measurement (full squares) is taken twice (full circles), it is possible that in one measurement and a given angle, the sample is in the high resistance state, whereas in a subsequent measurement at the same angle the sample is in the intermediate resistance state. The repeated measurement has received the legend “repeat” and is shown with full circles. In other words, this angular window exhibits a resistance bistability of the sample. It was verified in experiments that this bistability is present for a large range of the excitation voltages between 1.5 mV and 7.5 mV.

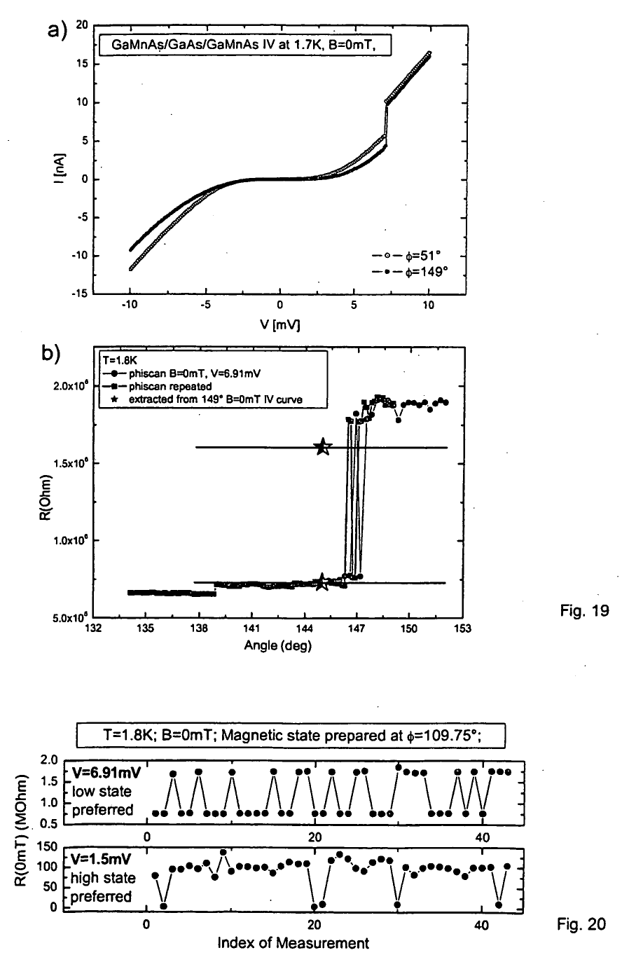

FIG. 19 shows in FIG. 19a) IV curve measured on the (Ga,Mn)As/GaAs/(Ga,Mn)As tunnel junction at zero magnetic field after preparing the magnetic state along φ=51° and φ=149°, close to the transition region of high and low resistance regimes in FIG. 17c. The measurement shows distinct discontinuities at V=7 mV which are evidence of current assisted switching. FIG. 19b) shows a correlation of the discontinuity of the 149° IV curve (stars) and the bistability of FIG. 18b suggests current assisted switching between the high and the intermediate (“90°”) resistance state of the sample. Therefore FIG. 19 is related to evidence of current induced/assisted switching of the magnetization.

In the following various experiments containing evidence that it is possible to influence the magnetic and thus the resistance state of a sample by applying appropriate currents are presented.

FIG. 19a presents two IV curves recorded by sweeping the excitation voltage from −10 to +10 mV and measuring the current through the (Ga,Mn)As/Gas/(Ga,Mn)As tunnel junction. The measurements were done at T=1.7K and zero magnetic field after the magnetic state had been prepared with a large magnetic field along φ=51° and φ=149° respectively. These angles are close to transition regions between high and low resistance states shown in FIG. 17c and therefore also close to the region shown in FIG. 18b showing the bistability. The most prominent feature of both IV curves is the discontinuity located at approximately 7 mV on the x-axis. The sample undergoes a sudden transition from a high resistance state to a much lower resistance state. The proximity of these features to the bistability region of FIG. 18b immediately leads to the assumption that the resistance drop in both experiments is of the same origin. In FIG. 19b we compare the discontinuity in the 149° IV curve (stars) with the bistability region around 147°. To be able to make the resistances comparable, the φ-scan was measured at a bias of 6.9 mV, close to location of the discontinuity in the IV curve. The agreement is good, especially for the 90°/intermediate resistance state. We therefore propose that the injection of a sufficiently high current into the tunnel structure in this case favors a transition from a parallel magnetization state to the 900 magnetization state.

FIG. 20 shows the magnetic state of the sample prepared with a large field along φ=146.75° which is inside the bistability window. Then the external field was brought to zero while applying a voltage to the sample. This procedure was repeated many times and the resulting resistance value at zero magnetic field is plotted vs. the index of the measurement.

FIG. 20 thus presents more evidence of the influence that current has on the magnetization behavior of the tunnel junction. The data is a compilation of many subsequent measurements where each time the magnetic state of the tunnel junction was prepared using a large magnetic field along φ=146.75°. This angle coincides with the bistability window displayed in FIG. 18b. During the experiment, the sample was constantly kept at a defined voltage bias chosen between 1.5 mV and 7.5 mV. After the external field had been lowered to zero, the resistance of the sample was measured. This procedure was repeated many times and the resulting resistance value at zero magnetic field is plotted vs. the index number. At all measured biases we see the coexistence of a higher and a lower resistance level. We also see that varying the excitation voltage shifts the balance between the occurrence of the higher and the lower resistance state. Higher biases clearly favor the formation of the lower resistance state and lower biases clearly favor the formation of the higher resistance state at this angle.

Our findings up to now indicate that an increase of the bias voltage in this experiment seems to increase the probability of the occurrence of the low resistance state. This is also immediately clear from the data shown in FIG. 20. These findings clearly support the fact that there is a clear and strong correlation between the current through the sample and its magnetic switching behavior.

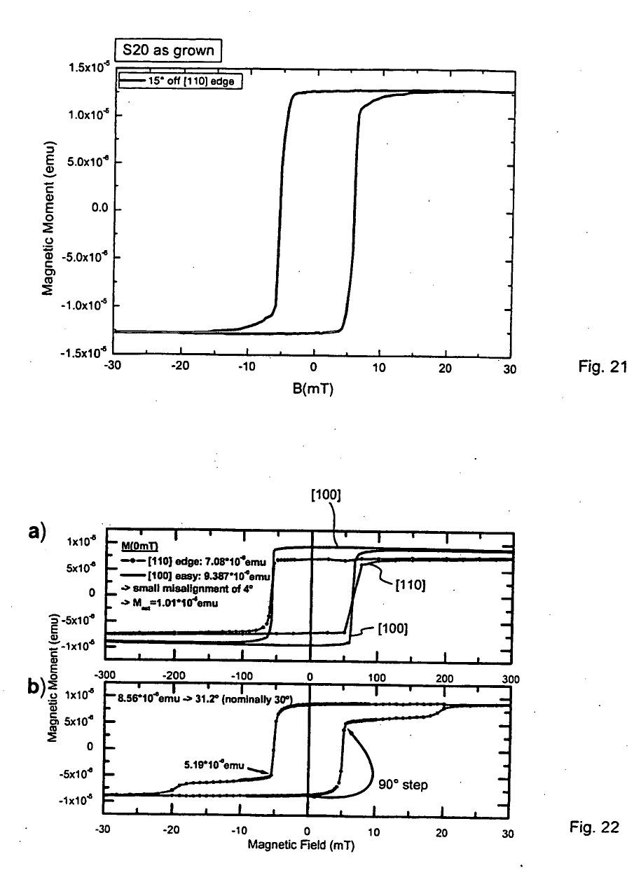

FIG. 21 shows SQUID on an as-grown specimen taken from the (Ga,Mn)As wafer S20. The measurement is conducted with the magnetic field oriented 15° off the [110] edge of the sample.

FIG. 22 shows SQUID measurements on a Au/AlOx/(Ga,Mn)As sample nominally identical to the single sided TAMR layer. The measurements confirm the validity of the employed magnetization reversal/magnetic anisotropy model. (a) Measurements with the magnetic field along the [100] easy and the [110] hard axis. (b) The measurement is conducted with the magnetic field oriented 15° off the [110] edge of the sample.

Said FIGS. 21 and 22 relate to the demonstration that the anisotropy of a ferromagnetic layer can be controlled by a surface layer on top of the ferromagnetic layer.

We conducted a series of SQUID measurements in order to investigate the influence of a ferromagnetic overlayer on the magnetic anisotropy and switching behavior of a ferromagnetic (Ga,Mn)As layer. A second objective of these SQUID measurements was to support the magnetic anisotropy/domain wall related switching mechanism model that was employed to explain the transport data.

In this sample the magnetization reversal always involves either two successive 900 switching events between the in plane anisotropy directions or a single 180° switching event on the global easy axis ([010] direction). In the magnetoresistance data, these switching events show up as sharp steps (or at certain angles, lack thereof). In SQUID, they show up as steps in the measured magnetic moment. In order to analyze the SQUID data, one has to keep in mind that a SQUID magnetometer does not measure the absolute value of the magnetization vector but rather only the projection of it onto the measurement axis. In our case the measurement axis is parallel with the axis of the applied magnetic field. This means that if the total magnetic moment of the sample is Mt and the vector points along an easy axis rotated by an angle φ with respect to the direction of the SQUID axis, then the measured moment Mm is given by Mm=Mt cos(φ).

FIG. 21 shows a SQUID measurement on an as-grown specimen taken from the (Ga,Mn)As wafer S20 (Which is the epilayer used in the fabrication of the (Ga,Mn)As/AlOx/Au transport devices) and FIG. 22 shows SQUID data measured on the same epilayer covered with AlOx and Au overlayers. The sample with the two overlayers is nominally identical to the single ferromagnet tunnel junction that showed TAMR. The measurement in FIG. 21 on the as grown sample is conducted with the magnetic field oriented 15° off the [110] edge of the sample. The same is true for the measurement in FIG. 22b on the sample with overlayers. This corresponds to an angle where the single sided spin valve sample showed very distinct and steep domain wall assisted switching features associated with a magnetization reversal with two successive 900 steps (“double step switching”). The SQUID measurement on the as grown sample without an overlayer does not show any significant signs of double step switching. The measurement of the covered sample in FIG. 22b on the other hand does show the double step switching, as is shown in the following analysis.

FIG. 22a contains a measurement with the magnetic field along the [110] hard axis of the layer and another one with the magnetic field along the [100] easy axis. From the magnitudes of the measured magnetic moments one easily concludes that the total magnetic moment of the layer is 1.01*10. This is extracted from the measurement of the [110] axis, because in our mounting scheme, an alignment along an edge of the sample is more accurate than an alignment along an easy axis, which is 45° rotated with respect to the edges (this SQUID measurement showed a 4° misalignment in the sample mounting). In FIG. 20b the remanent magnetization is 8.56*10⁻⁶ emu, which is the projection of the total magnetic moment that lies on an easy axis 31.2° off the magnetic field direction. This fits nicely to the nominal 30° alignment which was intended. The following large step in the hysteresis loop is associated with a 90° switching of the magnetization from [100] to [0-10], as predicted by our model.

In summary, the SQUID data confirms both our magnetic model and of the fact that an overlayer plays an important role in the magnetization behavior of the underlying (Ga,Mn)As layer.

In order to determine the influence of different overlayers on the ferromagnet, a number of additional SQUID experiments were conducted. They were all carried out on samples from wafer S20 in order to be able to compare them with the tunnel junction results. All of the examined overlayers modified the magnetic behavior of the as grown sample which is S20 covered with a thin AlOx over-layer.

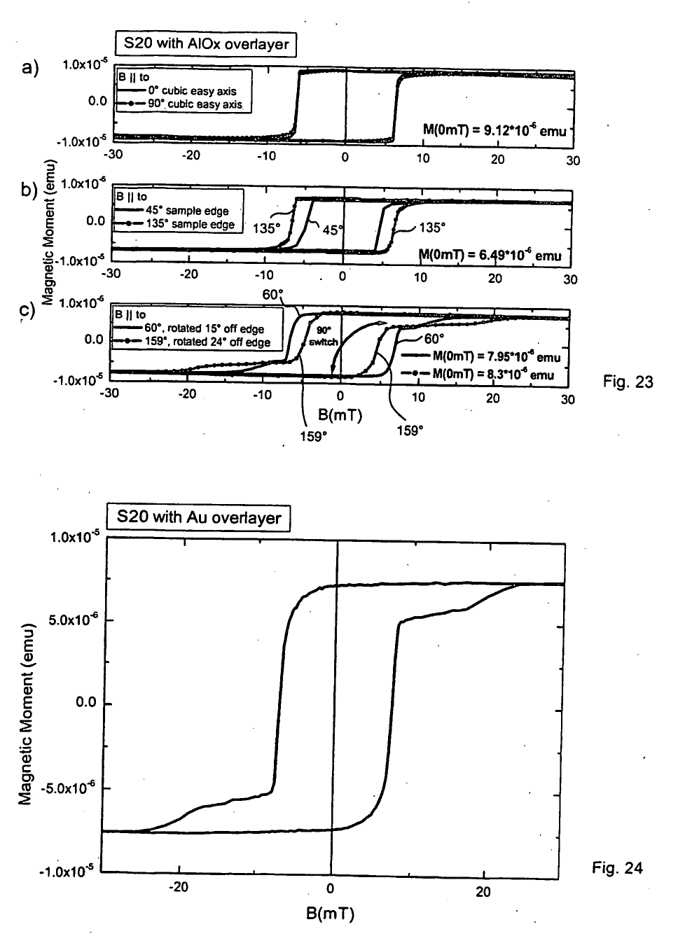

FIG. 23 displays various SQUID measurements conducted on a specimen from wafer S20 covered with AlOx only. FIG. 19a shows two measurements along the two cubic easy axes of the epilayer, corresponding to the 0° and 90° directions of the electrical magnetoresistance measurements of S20. The remanent magnetization is 9.12*10⁻⁶ emu. The measurements in FIG. 19b are conducted along the sample edges and they can be explained as simply being reduced by a factor of cos(45°). The same considerations can be applied to the measurement shown in FIG. 19c. The sample is mounted with the field at an angle of 15° off an edge of the sample, or in other words with the closest easy axis at roughly 30° off the direction of B. It is again the equivalent of the measurements shown in FIGS. 21 and 22b. By comparison it becomes apparent that the application of the AlOx overlayer also seems to lead to the occurrence of clear double step switching, since the 90° switch can be identified in the AlOx covered sample (FIG. 23c) but does not occur in the as grown sample (FIG. 21).

FIG. 24 shows a SQUID measurement on a 70 nm thick (Ga,Mn)As sample covered with a thin Au overlayer. Magnetic field at a small angle (<30°) with respect to one of the sample edges. The sample shows double step switching.

The same observation is made for a Au overlayer on top of S20. The SQUID measurement is displayed in FIG. 24. Also in this sample, we found that double step switching occurred with the magnetic field applied at a small angle with respect to one of the sample edges.

In summary, an overlayer on the ferromagnetic layer can significantly modify its magnetic anisotropy and/or switching behavior in a way that promotes double step magnetization reversal and is an important component of the pseudo-spin valve behavior of TAMR.

We have found out and note that the miscut (off-crystalline orientation) of the underlying substrate influences the magnetic anisotropy and magnetization reversal of the ferromagnetic layer

In order to support this hypothesis we grew a number of single ferromagnetic (Ga,Mn)As layers on top of intentionally miscut GaAs [001] substrates. The samples included:
S97A: no miscut
S97B: miscut 5°/[110], 90°
S97C: miscut 5°/[111], 90°
S97D: miscut 5°/[111], 180°

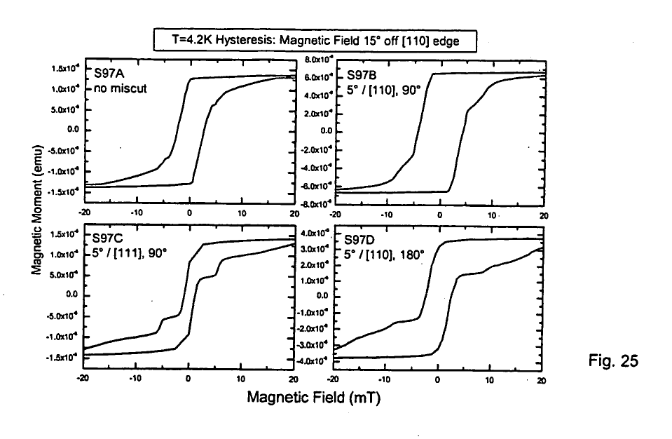

To maximize the comparability of the samples, the four different substrates were placed adjacent to each other in the MBE chamber. All growth conditions are therefore the same for all samples. After growth, small pieces sized approx. as 3*3 mm squares were cut and a series of SQUID measurements at T=4.2K was conducted on all of them. The question to be answered was how the samples would differ in terms of their magnetization reversal behavior and magnetic anisotropy. In order to maximize the visibility of double step switching in the SQUID signal, the samples were aligned with the measurement direction of the SQUID (and thus the external magnetic) at an angle of −15° from the [110] direction of the samples. The result of the SQUID measurements is that all the samples exhibit a different magnetization reversal. All the samples show indications of a double- or at least multistep reversal. From sample to sample, the steps are more or less pronounced, with the least pronounced being samples S97A and S97B. S97C and S97D exhibit richer and stronger features, as can be seen in FIG. 25. The exact role of miscut in the magnetization reversal of the covering (Ga,Mn)As epilayer can not yet be determined from these preliminary measurements alone but it is clear that miscut significantly modifies the magnetic anisotropy of the (Ga,Mn)As.

The following relate to Au/AlOx/(Ga,Mn)As and (Ga,Mn)As/GaAs/(Ga,Mn)As sample and growth details of the under-laying GaAs buffer. The anisotropy of an MBE grown ferromagnetic layer may be controlled by the details of the underlying layer. We employ a special method of buffer growth in all our (Ga,Mn)As based TAMR samples. The buffer is a bilayer, with the first buffer layer consisting of high temperature GaAs and the second layer being a thin layer of low temperature GaAs.

Before starting the growth, the GaAs substrate is heated to 630° C. for 10 minutes. As soon as the substrate temperature rises above 400° C., a small As flux is added. Then the substrate temperature is lowered slightly to 620° C. and a Ga flux is added. This starts the growth of the high temperature buffer layer. At a thickness of 300 nm, the substrate is allowed to cool towards 270° C. and as soon as it is below 570° C., the As flux is brought to zero, thus stopping the buffer growth. At this point the surface reconstruction is 2×4. The temperature is lowered further and when it reaches 270° C. it is held for 15 min. After that, the shutters of both the As and Ga elemental sources are opened for 30 seconds. Then the main shutter is opened for 10 seconds, allowing the low temperature GaAs buffer to grow. The surface reconstruction of the low temperature GaAs layer is 1x1. As soon as the targeted final thickness of 1 nm is reached, Mn flux is added to start the growth of the first functional ferromagnetic layer.

It may be crucial to use a very thin low temperature GaAs buffer to allow the reduced symmetry of the dangling bonds of the underlying high temperature GaAs to continue to influence the functional (Ga,Mn)As layers on top.

The idea behind this effect is to make use of the fact that while the bulk of the material, as well as the position of atoms at its surface, do have fourfold in-plane symmetry, the surface reconstruction of the dangling bonds may have reduced symmetry, and therefore lead to a lowering of the symmetry of the layer during the dynamic growth process.

It is possible to create semiconductor devices according to the above mentioned process, wherein more than two magnetic layers are provided, e.g. through reiteration of the method. Such a plurality of magnetic layers can amplify the effects and/or create a multiple resistance level system.

There exist a plurality of methods to create anisotropy in one or more magnetic layers. Several of preferred methods are the following. Such anisotropies can be produced by an annealing step within the fabrication step of the one or more magnetic layers. The anisotropy in one or more magnetic layers can be produced and/or controlled by the piezoelectric effect and/or magnetostriction effects and/or surface effects. These effects can be used independent from one another or they can be combined in a sequence of fabrication steps.

The anisotropy in one or more of the ferromagnetic electrodes can be produced by a cold rolling step or alternatively or additionally by application of a magnetic field during the layer growth.

A spin-valve structure provided according to the above description can comprise one or more magnetic layers produced with magnetic metallic alloys. Such a magnetic layer can comprise a CoFePt film.

It is contemplated to provide spin-valve structures wherein one or more of the magnetic layers comprise a magnetic metallic multilayer stack. Such a stack can comprise a series of CoFe and Pt thin films.

A different spin-valve structure comprises one or more of the magnetic layers with LaₓSr₁₋ₓMnO (LSMO), wherein 0<=x<=1.

It is also preferred to use a spin-valve structure wherein one or more of the magnetic layers comprise a Co and Pd multilayer structure.

Within spin-valve structures according to the invention the anisotropy in one or more magnetic layers can be produced and/or controlled by the piezoelectric effect and/or magnetostriction effects and/or surface effects. Furthermore it is possible to produce and/or control the anisotropy in one or more magnetic layers by an antiferromagnetic layer.

Within preferred spin-valve structures one or more of the ferromagnetic electrodes comprise magnetic multilayers.

Within spin-valve structures according to the invention one or more of the magnetic layers can comprise magnetite.

1-37. (canceled)

38. An electronic device comprising at least one layer in semiconductor materials, said at least one layer having a detecting current flow either perpendicular to or in the plane of the layer(s), functionally employing a stable partial reversal of the magnetization of the layer(s) in semiconductor materials, where this partial reversal produces a response which is characteristic of the orientation of the magnetization vector in the layer(s).

39. The electronic device according to claim 38, wherein this partial reversal is less than 180 degrees.

40. The electronic device according to claim 38, wherein the semiconductor is ferromagnetic.

41. The electronic device according to claim 38, wherein a lateral geometry is used whereby current flow occurs in the plane of the ferromagnetic layer.

42. The electronic device according to claim 38, wherein a lateral geometry is used and wherein the tunnel barrier is defined through patterning of the ferromagnetic layer and/or by depleting regions of the ferromagnetic layer.

43. The electronic device according to claim 38, wherein the electronic device is a spin-valve structure comprising a single ferromagnetic layer fitted with a tunnel barrier and a non-magnetic metal contact.

44. The electronic device according to claim 43, wherein a lateral geometry is used whereby current flow occurs in the plane of the ferromagnetic layer.

45. The electronic device according to claim 43, wherein a lateral geometry is used and the tunnel barrier is defined through patterning of the ferromagnetic layer and/or by depleting regions of the ferromagnetic layer.

46. The electronic device according to claim 43, wherein the magnetic and transport anisotropy are independently optimized.

47. The electronic device according claim 43, wherein the stable partial reverse magnetized state and effects dependant on said stable partial reverse magnetized state are dependant on and may be optimized by considering the strength and orientation of the magnetic field with respect to the tunnel barrier or other counterpart structure(s) within the electronic device.

48. The electronic device according to claim 3, characterized in that the stable partial reverse magnetized state and effects dependant on it is dependant on and may be optimized by choice of operating temperature(s).

49. The electronic device according to claim 40, wherein the structure is programmable in rotating magnetic fields above a predetermined threshold magnitude.

50. The electronic device according to claim 38, characterized in that the structure is sensitive to the absolute magnetic field direction.

51. The electronic device according to claim 40, wherein the ferromagnetic layer is selected from the group consociating of semiconductor ferromagnets, metallic ferromagnets and ferromagnetic oxides.

52. The electronic device according to claim 38, wherein the magnetization state of the spin-valve structure can be altered by using current above a specific threshold value.

53. The electronic device according to claim 38, wherein the amplitude of resistance effects in the spin-valve structure can be increased by the use of one or both of an epitaxial barrier and a second ferromagnetic layer.

54. The electronic device according to claim 38, wherein the device has more than two distinct resistance states.

55. The electronic device according to claim 54, wherein the more than two distinct resistance states are produced through use of nonparallel alignments of two ferromagnetic layers.

56. The electronic device according to claim 38, wherein one or more of the magnetic layers comprise magnetic metallic alloys.

57. The electronic device according to claim 38, wherein one or more of the magnetic layers comprise a magnetic metallic multilayer stack.

58. The electronic device according to claim 38, wherein one or more of the magnetic layers comprise LaₓSr₁₋ₓMnO (LSMO), wherein 0<=x<=1.

59. The electronic device according to claim 38, wherein one or more of the magnetic layers comprise a Co and Pd multilayer structure.

60. The electronic device according to claim 38, wherein the anisotropy in one or more magnetic layers is produced or controlled by the piezoelectric effect or magnetostriction effects or surface effects.

61. The electronic device according to claim 38, wherein the anisotropy in one or more magnetic layers is produced or controlled by an antiferromagnetic layer.

62. The electronic device according to claim 38, wherein one or more of the ferromagnetic electrodes comprise magnetic multilayers.

63. The electronic device according to claim 38, wherein one or more of the magnetic layers comprise magnetite.

64. A semiconductor device, comprising a substrate and a ferromagnetic layer on the substrate, wherein a tunnel barrier layer is provided on a first surface portion of the ferromagnetic layer, said tunnel barrier layer having a first non-magnetic metallic contact, and wherein a second non-magnetic metallic contact is provided on a second portion of the ferromagnetic layer.

65. The semiconductor device according to claim 64, wherein the first surface portion is a central portion and the second surface portion is a surrounding portion.

66. The semiconductor device according to claim 64, wherein more than two magnetic layers are used in order to amplify the effects and/or to create a multiple resistance level system.

67. A method for producing a spin-valve structure, comprising:
(a) providing a substrate,
(b) growing a ferromagnetic layer on the substrate,
(c) growing a tunnel barrier layer on the ferromagnetic layer,
(d) providing a first non-magnetic metallic contact on the ferromagnetic layer, and
(e) providing a second non-magnetic metallic contact for the ferromagnetic layer.

68. The method according to claim 67, wherein the step of providing the second non-magnetic metallic contact for the ferromagnetic layer consists of, either only partially growing the tunnel barrier layer and the first non-magnetic metallic contact on the ferromagnetic layer or etching away portions of the tunnel barrier layer and the first non-magnetic metallic contact to obtain a free surface of the ferromagnetic layer opposite to the substrate and providing the second non-magnetic metallic contact on a portion of said free surface on the ferromagnetic layer.

69. The method according to claim 67, further providing one or both of an epitaxial barrier and a second ferromagnetic layer as such that the amplitude of resistance effects in the spin-valve structure can be increased by the use of one or both of an epitaxial barrier and a second ferromagnetic layer.

70. The method according to claim 67, wherein the anisotropy in one or more magnetic layers is produced by annealing.

71. The method according to claim 67, wherein the anisotropy in one or more magnetic layers is produced and/or controlled by at least one effect selected from the group consisting of piezoelectric effects, magnetostriction effects, and surface effects.

72. The method according to claim 67, wherein the anisotropy in one or more of the ferromagnetic electrodes is produced by cold rolling.

73. The method according to claim 67, wherein the anisotropy in one or more of the ferromagnetic electrodes is produced by application of a magnetic field during the layer growth.

74. The method according to claim 67, wherein the independent optimization of the magnetic and transport anisotropy of the ferromagnetic layer or the process of magnetization reversal is controlled by at least one of the surface reconstruction, surface symmetry, or lattice constant of the underlying layer, or by off-crystalline orientation of the underlying substrate.

75. The method according to claim 67, wherein the independent optimization of the magnetic and transport anisotropy of the ferromagnetic layer or the process of magnetization reversal is controlled by a layer on top of the ferromagnetic layer.

76. The electronic device according to claim 39, wherein the partial reversal is less than 90 degrees.

77. The electronic device according to claim 56, wherein the magnetic metal alloy is CoFePt film.

78. The electronic device according to claim 57, wherein the magnetic multilayer stack is a series of CoFe and Pt thin films.
